(19) United States
(12) Patent Application Publication
(10) Pub. No.: US 2005/0206793 A1
(43) Pub. Date: Sep. 22, 2005

(54) Projection television apparatus

(76) Inventors: Sang-hak Kim, Suwon-si (KR); Sung-soo Jung, Suwon-si (KR)

Correspondence Address: STANZIONE & KIM, LLP, 1740 N STREET, N.W., FIRST FLOOR, WASHINGTON, DC, 20036, US

(21) Appl. No.: 10/975,088

(22) Filed: Oct. 28, 2004

(30) Foreign Application Priority Data
Mar. 20, 2004 (KR) 2004-19116

(51) Int. Cl. H04N 5/74

(52) U.S. Cl. 348/749

(57) ABSTRACT

A projection television apparatus includes a CRT, a lens provided in front of the CRT, a coupler provided between the CRT and the lens and having a coolant accommodating part and a coolant injection port, a shock absorber provided on the coolant injection port to elastically change its shape corresponding to a pressure change inside the coolant accommodating part, a support cap that compressively supports the shock absorber and has a discharge port on a side thereof, and a coolant outflow preventing member connected to the discharge port to accommodate a coolant flowing into the support cap due to a damage of the shock absorber.

### CROSS-REFERENCE TO RELATED APPLICATIONS

This application claims the benefit of Korean Patent Application No. 2004-19116, filed Mar. 20, 2004, in the Korean Intellectual Property Office, the disclosure of which is incorporated herein by reference.

### BACKGROUND OF THE INVENTION

1. Field of the Invention

The present general inventive concept relates to a projection television apparatus, and more particularly, to a projection television apparatus having a shock absorber that prevents an outflow of a coolant inside a CRT assembly and can absorb an inner pressure change of the coolant.

2. Description of the Related Art

Generally, a projection television is to form an image by projecting a video beam to a rear of a screen using a projector. The projection television has an advantage to provide a wide picture, so that demand thereon has become changed.

As shown in FIG. 1, a CRT assembly of a conventional projection television includes a cathode ray tube (CRT) 1, a lens 2 provided in front of the CRT 1, and a coupler 3 provided between the CRT 1 and the lens 2.

The coupler 3 has openings on upper and lower surfaces. The lens 2 and the CRT 1 pass through the openings to form the coolant accommodating part 4 to accommodate a coolant C therebetween. A coolant injection port 5 is formed on a side of the coupler 3 to inject the coolant C therethrough. A shock absorber 6 made of an elastic material, such as rubber, and a support cap 7 to closely support the shock absorber 6 are provided on the coolant injection port 5.

The shock absorber 6 is employed to prevent the coolant C from flowing out of the coolant accommodating part 4 and to accept (absorb) a pressure change inside the coolant accommodating part 4 due to heat generated from the CRT 1.

However, the shock absorber 6 may be damaged if a pressure inside the coolant accommodating part 4 is repeatedly changed for a long period of time. A malfunction of electric/electronic components, such as a printed circuit board, may occur if the coolant C flows out of the CRT assembly due a damage of the shock absorber 6.

### SUMMARY OF THE INVENTION

In order to solve the above-mentioned and/or other problems, it is an aspect of the general inventive concept to provide a projection television to prevent a coolant that flows out of a coolant accommodating part of a CRT assembly from being exposed to an outside of the CRT assembly.

Additional aspects and/or advantages of the general inventive concept will be set forth in part in the description which follows and, in part, will be obvious from the description, or may be learned by practice of the invention.

The foregoing and/or other aspects of the general inventive concept are achieved by providing a projection television including a CRT, a lens provided in front of the CRT, a coupler provided between the CRT and the lens and having a coolant accommodating part and a coolant injection port, a shock absorber provided on the coolant injection port to elastically change its shape corresponding to a pressure change inside the coolant accommodating part, a support cap that compressively supports the shock absorber and has a discharge port on a side thereof, and a coolant outflow preventing member connected to the discharge port to accommodate a coolant flowing into the support cap due to a damage of the shock absorber.

According to an aspect of the general inventive concept, the coolant outflow preventing member can include a tube connected to the discharge port of the support cap and an oil pack connected to the tube.

According to another aspect of the general inventive concept, the oil pack of the coolant outflow preventing member can be connected to the discharge port of the support cap.

According to yet another aspect of the general inventive concept, the oil pack is made of a material to form a film.

### BRIEF DESCRIPTION OF THE DRAWINGS

These and other aspects and advantages of the general inventive concept will become apparent and more readily appreciated from the following description of the embodiments, taken in conjunction with the accompany drawings of which:

FIG. 1 is a sectional view of a CRT assembly of a conventional projection television;

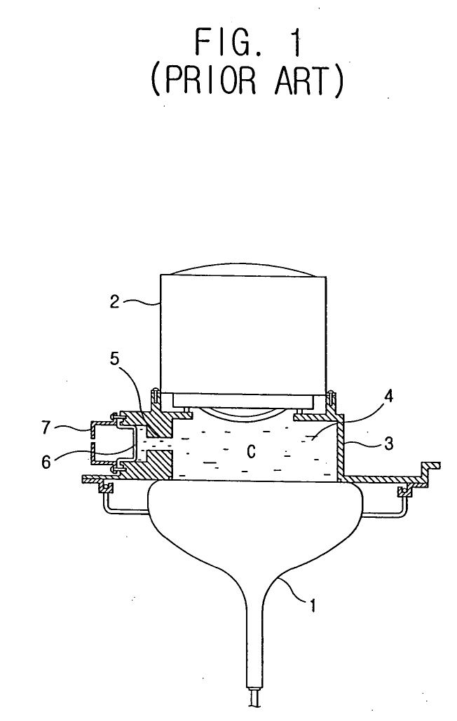

FIG. 2 is a perspective view showing an inside of a projection television apparatus according to an embodiment of the present general inventive concept;

FIG. 3 is an exploded perspective view showing a CRT assembly of the projection television apparatus in FIG. 2;

FIG. 4 is an assembled perspective view showing the CRT assembly of the projection television apparatus in FIG. 3;

FIG. 5 is a sectional view showing the CRT assembly of the projection television apparatus in FIG. 3; and

FIG. 6 is a sectional view showing a CRT assembly according to another embodiment of the present general inventive concept.

### DETAILED DESCRIPTION OF THE PREFERRED EMBODIMENTS

Reference will now be made in detail to the embodiments of the general inventive concept, examples of which are illustrated in the accompanying drawings, wherein like reference numerals refer to like elements throughout. The embodiments are described below in order to explain the general inventive concept by referring to the figures.

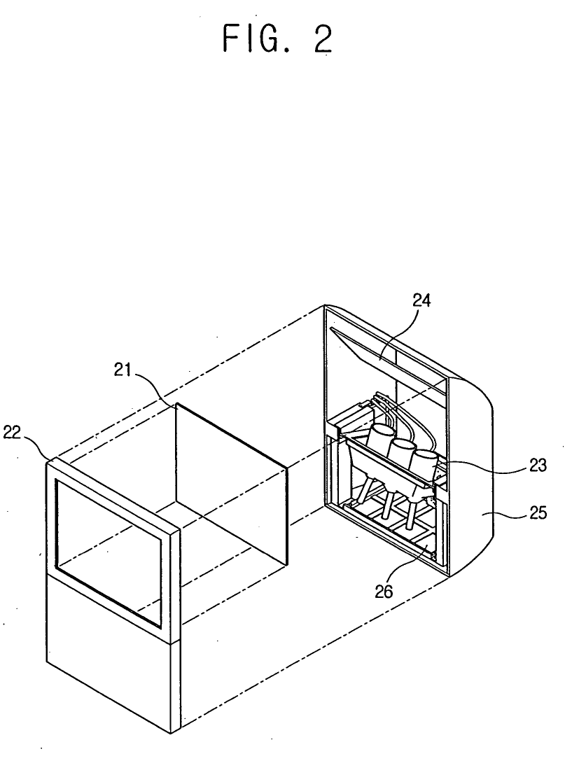

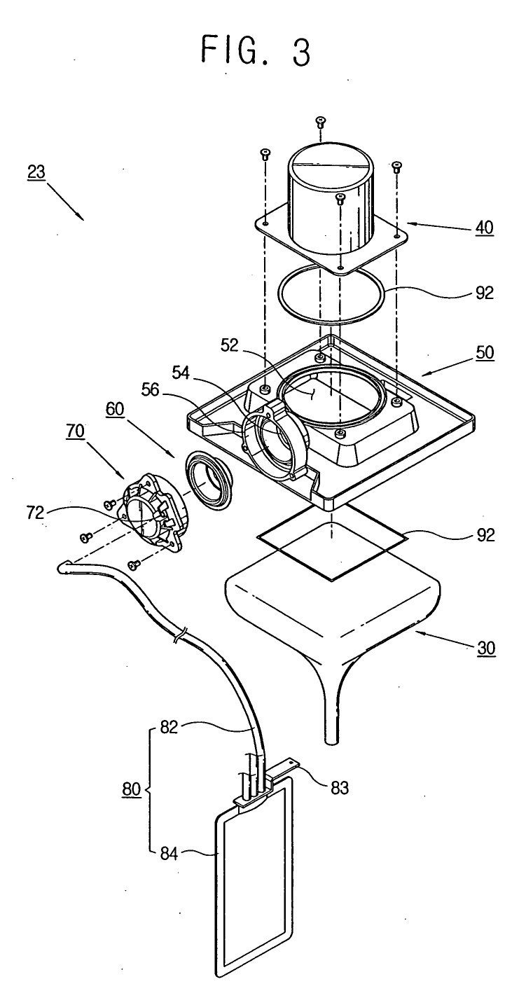

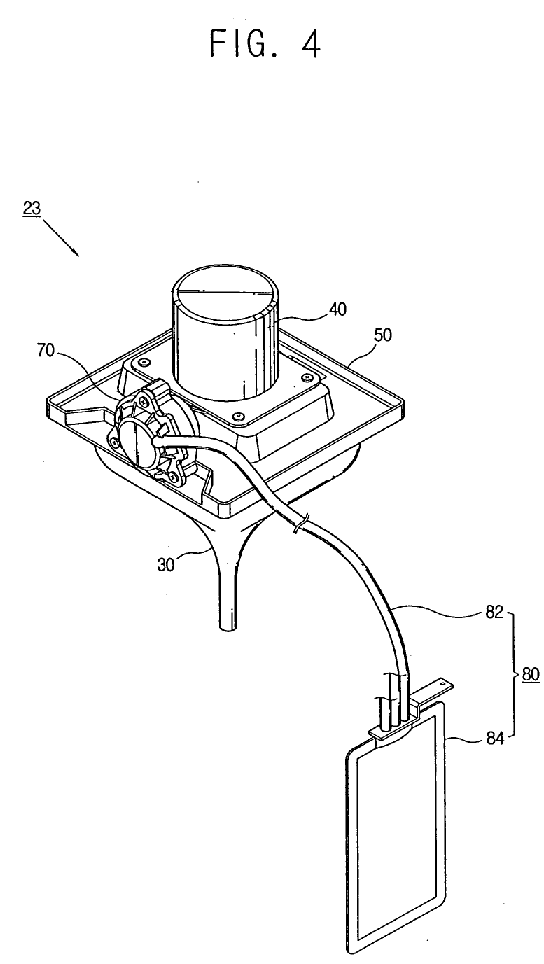

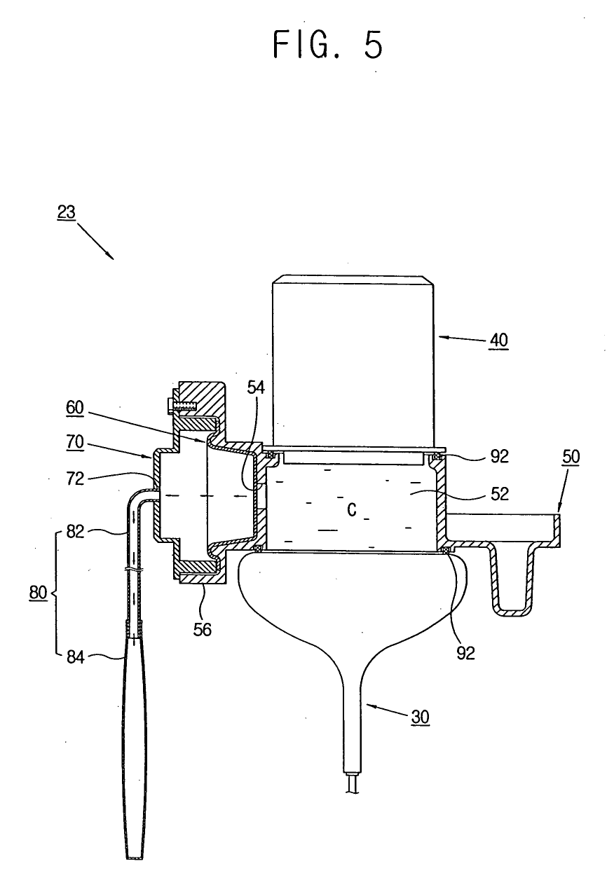

FIG. 2 is a perspective view showing an inside of a projection television apparatus (projection TV or projection apparatus) according to an embodiment of the present general inventive concept, and FIGS. 3-5 are an exploded perspective view, an assembled perspective view, and a sectional view, respectively, showing a CRT assembly of the projection television apparatus in FIG. 2. As shown FIG. 2, the projection TV may include a screen 21 to display an image, a front mask 22 provided in front of the screen 21, a CRT assembly 23 provided at the back of the screen 21 to project a video beam to the screen 21, a reflection mirror 24 to reflect the video beam projected from the CRT assembly 23 to a rear of the screen 21, and a casing 25 connected to a rear of the front mask 22 to accommodate the CRT assembly 23 and the reflection mirror 24.

The screen 21 can include a circumference supported by a support bracket (not shown) to be connected to the rear of the front mask 22 and can also include a Lenticular lens or a Fresnel lens.

The front mask 22 can have a size enough to cover the screen 21, and a frame thereof covers a circumference of the screen 21 to form an external appearance.

The CRT assembly 23 can be provided in a lower part of the casing 25 to project the video beam to the reflection mirror 24.

The casing 25 can form rear and side appearances of the projection TV and connected to the front mask 22 by a fastener such as a screw. The CRT assembly 23 can project the video beam to form the image and can be accommodated to be disposed in the lower part inside the casing 25. The reflection mirror 24 to reflect the video beam projected from the CRT assembly 23 to the screen 21 can be inclined with respect to the screen and can be provided on an upper part inside the casing 25. A printed circuit board (PCB) 26 to control the CRT assembly 23 and the like can be provided on a bottom of the casing 25.

As shown in FIGS. 3 through 5, the CRT assembly 23 may include a CRT 30, a lens 40 provided in front of the CRT 30, a coupler 50 provided between the CRT 30 and the lens 40 and including a coolant accommodating part 52 and a coolant injection port 54, a shock absorber 60 provided on the coolant injection port 54 to elastically change its shape corresponding to a pressure inside the coolant accommodating part 52, and a support cap 70 that has a discharge port 72 on a side thereof and compressively supports the shock absorber 60 and a coolant outflow preventing member 80 to put a coolant therein, wherein the coolant flows into the support cap 70 due to a damage of the shock absorber 60.

Each of the CRT 30 and the lens 40 can be sealed with the coupler 50 using each of sealing members 92 and can be securely connected to the coupler 50 by a fastener, such as a screw, in a state that each of the CRT 30 and the lens 40 contacts to the coupler 50.

The coupler 50 can include a main body having a substantially rectangular shape and openings on opposite surfaces. The lens 40 and the CRT 30 can communicate with each other through the openings to form the coolant accommodating part 52 to accommodate the coolant C therebetween. The coolant injection port 54 formed on a side of the coupler 50 is to inject the coolant C therethrough.

The coolant C is to cool heat generated from the CRT 30 and ethylene glycol and glycerin are used as the coolant C. As an aspect of the present invention, the coupler 50 is made of aluminum having a high heat resistance.

A concave flange 56 can be provided on a circumference of the coolant injection port 54 to receive the shock absorber 60, and the shock absorber 60 inserted in the flange 56 can be closely supported by the support cap 70. The support cap 70 that closely supports the flange 56 can be screw-connected to the flange 56 to securely support the flange 60.

The shock absorber 60 can tightly shut the coolant accommodating part 52 and can elastically change its shape corresponding to a pressure difference (pressure change) of the coolant C, because of characteristics of its material. That is, the shock absorber 60 can prevent the coolant C from flowing out of the coolant accommodating part 52 and can elastically change its shape according to a temperature change caused when the coolant C is expanded and contracted to accept (absorb) the pressure change of the coolant C. Thus, the shock absorber 60 can be made of rubber, but not limited thereto. All of materials may be used for the shock absorber 60 as long as it can change its shape corresponding to the pressure change inside the coolant accommodating part 52.

The support cap 70 can store the coolant C therein when the coolant C flows out of the coolant accommodating part 52 due to the damage of the shock absorber 60. If an amount of an outflow of the coolant C is more than a predetermined amount, the coolant C can be discharged to the coolant outflow preventing member 80 through the discharge port 72. The discharge port 72 may be provided under the support cap 70, so that the coolant C is discharged to the coolant outflow preventing member 80 at the same time when the coolant C flows into the support cap 70. If the CRT assembly 23 has no coolant outflow preventing member 80 and the coolant flows out of the CRT assembly 23, a malfunction of electric/electronic components, such as the PCB 26 (refer to FIG. 2) and the like, may occur.

The coolant outflow preventing member 80 may include a tube 82 detachably connected to the discharge port 72 of the support cap 70 and an oil pack 84 in communication with the tube 82.

The tube 82 can be detachably and securely connected to the discharge port 72 of the support cap 70 and the oil pack 84. As an aspect of the present general inventive concept, the tube 82 can be made of synthetic resin having a high durability and a high protection against chemical substances. A shape of the tube 82 may be varied according to an external condition.

As another aspect of the present general inventive concept, the oil pack 84 is made of a material to be formed as a film, but not limited thereto. All of materials may be used for the oil pack 84 as long as it can put the coolant C therein with safety. A locking part 83 can be provided at a part of the oil pack 84, which provides a convenience to install and keep the oil pack 84.

In the above embodiment, a plurality of tubes 82 can be connected to one oil pack 84, but not limited thereto. The number of oil packs 84 may be the same of that of the tubes 82, as required. Although only one CRT assembly is shown in this embodiment, more than two CRT assemblies can be provided since the projection apparatus may have more than two CRT. Thus, one coolant outflow prevent member can be connected to more than two CRT assembly. Otherwise, a plurality of coolant outflow prevent members can be provided to corresponding to a plurality of CRT assemblies.

It was considered that, an enclosed type support cap 70 can be used to prevent the coolant C from being exposed to an outside of the CRT assembly 23. However, then, the shock absorber 60 may be operated not smoothly and a problem may occur when the amount of coolant C flowing out of the shock absorber 60 is greater than a reference amount.

A volume of the coolant C can be increased if it directly contacts to air to absorb moisture in the air.

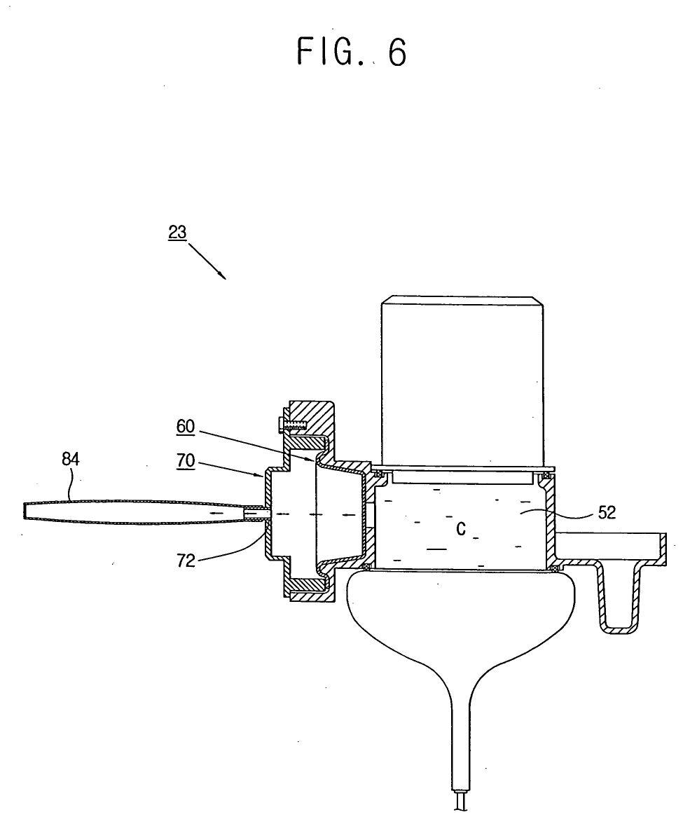

FIG. 6 shows a CRT assembly 23 according to another embodiment of the present general inventive concept. As shown in FIG. 6, an oil pack 84 can be directly connected to a discharge port 72 of a support cap 70 without a tube 82. Otherwise, the configuration and the function of the CRT assembly 23 can be the same as those of the embodiment shown in FIGS. 3 through 5, and a detailed description will be omitted.

As described above, the coolant can be prevented with efficiency from flowing out of the shock absorber due to the damage of the shock absorber to be exposed to the outside of the CRT assembly.

Thus, the malfunction of the electric/electronic components, such as the PCB, caused due to the outflow of the coolant can be prevented with efficiency.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A projection television apparatus comprising:
a CRT;
a lens provided in front of the CRT;
a coupler provided between the CRT and the lens, and having a coolant accommodating part to contain a coolant, and a coolant injection port formed on the coolant accommodating part;
a shock absorber provided on the coolant injection port to elastically change its shape corresponding to a pressure change inside the coolant accommodating part;
a support cap that compressively supports the shock absorber and has a discharge port on a side thereof; and
a coolant outflow preventing member connected to the discharge port of the support can to accommodate the coolant flowing into the support cap due to a damage of the shock absorber.

2. The projection television according to claim 1, wherein the coolant outflow preventing member comprises a tube connected to the discharge port of the support cap and an oil pack connected to the tube.

3. The projection television according to claim 2, wherein the oil pack is made of a material to form a film.

4. The projection television according to claim 1, wherein the coolant outflow preventing member comprises an oil pack connected to the discharge port of the support cap.

5. The projection television according to claim 4, wherein the oil pack is made of a material to form a film.

6. A projection television apparatus comprising:
a CRT;
a lens provided in front of the CRT;
a coupler coupled between the CRT and the lens, having a coolant accommodating part to contain a coolant, and having an opening formed thereon to provide a passage of the coolant;
a shock absorber to cover the opening to absorb a pressure change of the coolant accommodating part;
a support cap coupled to the coupler to form a chamber with the shock absorber to receive the coolant, and having a discharging port formed on a side of the chamber; and
a coolant outflow preventing member to cover the discharging port to receive the coolant flowing from the chamber through the discharging port.

7. The projection television according to claim 6, wherein the coolant outflow preventing member is made of a flexible material to be attached to the support cap.

8. The projection television according to claim 6, wherein the coolant outflow preventing member comprises an inside to receive the coolant flowing from the opening of the coolant accommodating part through the shock absorber and the discharging port.

9. The projection television according to claim 6, wherein the coolant outflow preventing member comprises a pack having an inlet corresponding to the discharging port of the support cap, and the coolant flowing through the discharging port is stored in an inside of the pack.

10. The projection television according to claim 9, wherein the pack of the coolant outflow preventing member has a width and a length longer than the width.

11. The projection television according to claim 10, wherein the width of the pack of the coolant outflow preventing member corresponding to a diameter of the discharging port.

12. The projection television according to claim 9, wherein the coolant outflow preventing member comprises a tube detachably attached between discharging port and the inlet of the pack.

13. The projection television according to claim 10, wherein the tube of the coolant outflow preventing member comprises a first end extended from the discharging port in a first direction and a second end extended from the first end in a second direction having an angle with the first direction.

14. The projection television according to claim 6, wherein the coolant outflow preventing member comprises a sealed inside except an inlet coupled to the discharging port.

15. The projection television according to claim 6, wherein the coolant outflow preventing member comprises a sealed flexible pack having an inlet to communicate with the chamber of the coupler through the discharging port.

16. The projection television according to claim 6, wherein the discharging port protrudes from the coupler in a direction away from the shock absorber, and the coolant outflow preventing member is coupled to an outside circumferential surface of the discharging port.

17. The projection television according to claim 6, wherein the coolant outflow preventing member has an inside volume varying depending on the coolant flowing from the chamber through the discharging port.

18. The projection television according to claim 6, wherein the coolant outflow preventing member comprises a tube coupled to the discharging port, a pack connected to the tube, and a locking part connected between the tube and the pack to selectively blocking a passage between the tube and the pack.

19. The projection television according to claim 6, wherein the discharging port is disposed opposite to the opening with respect to the shock absorber, and the opening is a coolant injection port through which the coolant is injected into the coolant accommodating part.

20. The projection television according to claim 6, further comprising;
a second CRT;
a second lens provided in front of the second CRT;
a second coupler coupled between the second CRT and the second lens, having a second coolant accommodating part to contain a second coolant, and having a second opening formed thereon to provide a second passage of the second coolant;
a second shock absorber to cover the second opening to absorb a second pressure change of the second coolant accommodating part; and
a second support cap coupled to the second coupler to form a second chamber with the second shock absorber, and having a second discharging port formed on a side of the second chamber,
wherein the coolant outflow preventing member covers the second discharging port to receive the second coolant flowing from the second chamber through the second discharging port.
